(19) United States
(12) Patent Application Publication
(10) Pub. No.: US 2024/0318464 A1
(43) Pub. Date: Sep. 26, 2024

(54) INTERLOCKING SYSTEM FOR AN ACCESS-CONTROLLED AREA

(71) Applicant: 3M INNOVATIVE PROPERTIES COMPANY, St. Paul, MN (US)

(72) Inventors: Timothy N. Thompson, Lake City, MN (US); Jonathan J. Lepp, Eagan, MN (US); Scott E. Brigham, Maplewood, MN (US)

(21) Appl. No.: 18/579,610

(22) PCT Filed: Aug. 12, 2022
(86) PCT No.: PCT/IB2022/057555

§ 371 Date: Jan. 16, 2024

Related U.S. Application Data
(60) Provisional application No. 63/232,962, filed on Aug. 13, 2021.

(51) Int. Cl. E05B 47/00; A62B 35/00; F16P 1/00

(52) U.S. Cl. CPC E05B 47/0002; A62B 35/0037; F16P 1/00; A62B 35/0056; A62B 35/0093; E05B 2047/0068; E05B 2047/0094

(57) ABSTRACT

A fall-protection interlocking system for an access-controlled fall-risk area. The system includes a latch module installed at an entry gate of the area and a fall-protection apparatus installed at the area. The interlocking system further includes a monitoring system configured to send a positive signal to the latch module when the fall-protection monitoring system determines that a connector of a safety line of the fall-protection apparatus appears to be connected to a safety harness of a user. Upon receipt of the positive signal, the low-power-consumption latch module can unlatch the entry gate.

### BACKGROUND

Areas that are access-controlled because they present fall risks are often present e.g. in industrial facilities, in cargo-loading of trucks, railcars, and aircraft, and in other environments. Such areas may benefit from the use of fall-protection apparatus and systems.

### SUMMARY

In broad summary, herein is disclosed a fall-protection interlocking system for an access-controlled fall-risk area. The interlocking system includes a latch module installed at an entry gate of the area and a fall-protection apparatus installed at the area. The interlocking system further includes a monitoring system configured to send a positive signal to the latch module when the fall-protection monitoring system determines that a connector of a safety line of the fall-protection apparatus appears to be connected to a safety harness of a user. Upon receipt of the positive signal, the low-power-consumption latch module can unlatch the entry gate. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a perspective view of an access-controlled area equipped with an entry gate, a fall-protection system, and a fall-protection monitoring system.

FIG. 2 is a front view of an exemplary fall-protection apparatus.

FIG. 3 is a perspective view of another exemplary fall-protection apparatus.

FIG. 4 is a rear view of an exemplary fall-protection harness.

Like reference numbers in the various figures indicate like elements. Some elements may be present in identical or equivalent multiples; in such cases only one or more representative elements may be designated by a reference number but it will be understood that such reference numbers apply to all such identical elements. All figures and drawings in this document are not to scale and are chosen for the purpose of generically illustrating representative embodiments of the invention. In particular the dimensions of the various components are depicted in illustrative terms only, and no relationship between the dimensions of the various components should be inferred from the drawings, unless so indicated. Although terms such as “first” and “second” may be used in this disclosure, it should be understood that those terms are used in their relative sense only unless otherwise noted. Furthermore, such terms do not invoke any temporal order unless specifically noted. Terms such as vertical, upward and downward, above and below, and so on, have their ordinary meaning with respect to the Earth's gravity. The horizontal direction likewise has its ordinary meaning as any direction perpendicular to the vertical direction. The term “configured to” and like terms is at least as restrictive as the term “adapted to”, and requires actual design intention to perform the specified function rather than mere physical capability of performing such a function.

### DETAILED DESCRIPTION

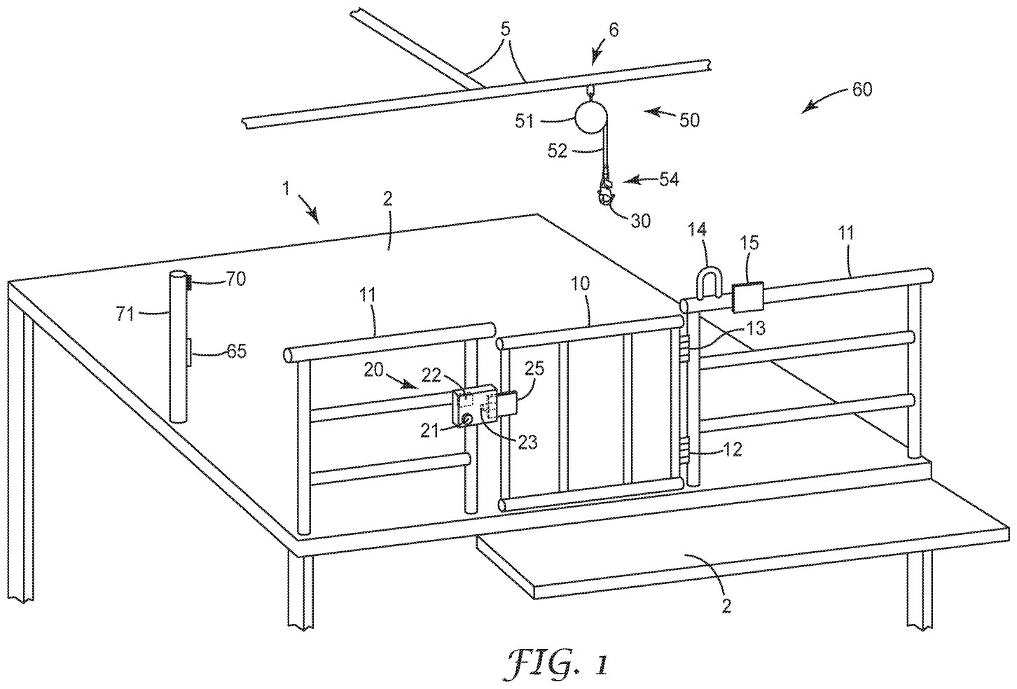

Disclosed herein is a fall-protection interlocking system for an access-controlled area. An area 1 that is access-controlled because it presents a fall risk is shown in generic, representative illustration in FIG. 1. Such an area may be e.g. an elevated platform or mezzanine 3 as in the exemplary depiction of FIG. 1; however, many variations and types of access-controlled areas exist as discussed later herein. Such an area 1 may often comprise a barrier to entry e.g. in the form of a stationary barrier (e.g. a wall, fence, guardrail, or the like) 11 that is equipped with an entry gate 10 that can be opened to allow an authorized person to enter the access-controlled area.

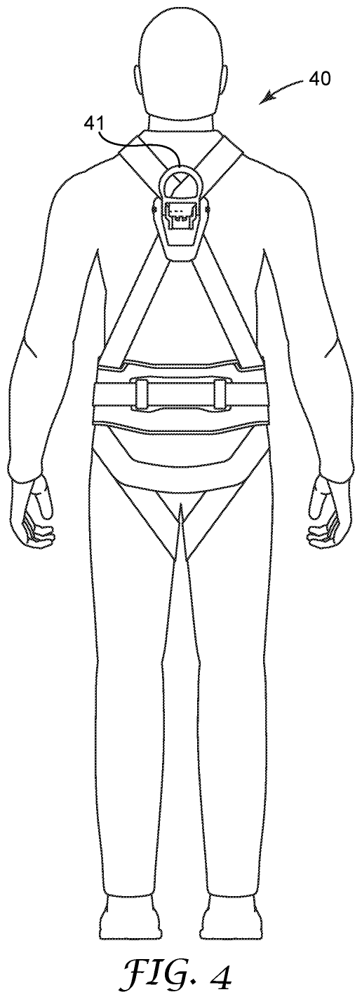

The herein-disclosed interlocking system comprises at least one fall-protection apparatus 50 that is installed at access-controlled area 1 and that comprises a safety line 52 with a distal end 54 that comprises a connector 30. Connector 30 is configured to be connected to a safety harness 40 worn by a human user (as illustrated in FIG. 4) of the access-controlled area. The interlocking system further comprises a latch module 20 that is installed at the entry gate. The interlocking system still further comprises a fall-protection monitoring system 60 that is configured to determine whether the connector 30 of safety line 52 appears to be connected to the safety harness 40 of the user. Monitoring system 60 is in communication with latch module 20 and can send a positive signal to the latch module when the monitoring system determines that the connector 30 appears to be connected to the safety harness 40. The latch module 20 is configured so that upon receipt of the positive signal from monitoring system 60, latch module 20 unlatches entry gate 10 so that the user can enter access-controlled area 1.

The fall-protection apparatus 50 of the interlocking system is configured so that the distal end 54 of safety line 52, in particular the connector 30 that is provided at the distal end of the safety line, is graspable by the user when the user is located at a position 2 that is outwardly-proximate entry gate 10. By outwardly-proximate is meant a position that is outward of gate 10 (that is, a position that is not within access-controlled area 1) and that is within five horizontal feet of gate 10. (In some instances a user may be able to grasp the connector even when the user is somewhat more than five feet away from gate 10.)

An outwardly-proximate position 2 is depicted in exemplary representative embodiment in FIG. 1. It is emphasized that FIG. 1 is a generic representation with various items omitted or simplified. In particular, position 2 is depicted in FIG. 1 in simplified, generic representation. It will be appreciated that in actuality an area 2 that is outside access-controlled area 1 will not exhibit any significant fall-risk (e.g. is not positioned vertically upward from an adjacent area), and/or will be adequately fall-protected e.g. by barriers such as railings or walls.

The herein-disclosed arrangements allow a user to approach an entry gate 10 to an access-controlled area 1; and, while positioned in a location 2 that is outwardly-proximate to entry gate 10, the user can reach, and grasp, a connector 30 of a fall-protection apparatus 50. During this time (e.g., generally at any time during which an authorized user is not actually entering area 1 or present in area 1), gate 10 will be closed with latch module 20 keeping entry gate 10 latched so that gate 10 cannot be opened. The user, located in area 2 outside the entry gate, is able to reach and grasp connector 30 and to connect it to the user's harness while the user is still outside of access-controlled area 1.

Upon the user connecting the connector 30 of fall-protection apparatus 50 to the user's harness 40, the fall-protection monitoring system will detect that the connector appears to be connected to the safety harness and will send a “positive” signal to the latch module. Upon receipt of the positive signal, latch module 20 will unlatch gate 10 so that gate 10 can now be opened and the user can enter area 1. Once the user is within access-controlled area 1, the user can move about and e.g. perform various work activities, while remaining protected by the fall-protection apparatus 50.

The herein-disclosed arrangements provide that an access-controlled area 1 can be interlocked with a fall-protection apparatus 50, meaning that an entry gate 10 of the access-controlled area can be opened only if it is detected that the user appears to be properly protected by a fall-protection apparatus 50 and harness 40. Such arrangements may be configured in numerous ways and used in various ways. A variety of such arrangements, configurations, and methods of use will be discussed herein. It will be appreciated that all such arrangements are exemplary.

### Latch Module

The herein-disclosed arrangements rely on a latch module 20 that is installed at entry gate 10. By a latch module is meant not only an actual physical “latch” that is movable to perform the actual latching and unlatching of the gate, but all associated circuitry and ancillary items and components needed to receive a positive signal from the fall-protection monitoring system and to cause the physical latch to move upon receipt of such a signal. A physical latch 21 is depicted in exemplary, generic illustration in FIG. 1 (such an entity may be variously referred to as a latch, bolt or pin, with the term “bolt” being used hereafter to avoid confusion with latch module 20). Such a bolt 21 may be movable back and forth between an unlatched position in which it allows a tang 25 of gate 10 to pass by without interference, and a latched position in which bolt 21 physically prevents tang 25 from moving in a direction that corresponds to gate 10 opening. In the depicted arrangement, bolt 21 is slidably movable along a direction that is generally horizontal and is generally aligned with the long axis of gate 10. It is noted however that the depicted arrangement is exemplary and that a latch module may rely on any suitable latching arrangement utilizing any type of motion (e.g. translational or rotational) and relying on any suitable driving force (e.g. electromagnetic, pneumatic, and so on).

In at least some embodiments, a latch module 20 will be a normally-latched module (and thus the entry gate 10 will be a normally-latched gate). By this is meant that the latch module is normally held in the latched configuration; in other words, it will remain latched unless and until a user carries out the steps disclosed herein to cause the latch to be unlatched so that the user can enter through the entry gate. Thus for example, a normally-latched gate will remain latched during off-hours and when not being accessed by an authorized user. As made clear by discussions herein, in some embodiments the latch module will relatch after a user's entry and then remain latched during the time that the user is within the access-controlled area. In other words, in some embodiments the latch module will only unlatch for a short time to allow a user to enter the access-controlled area, after which it will relatch. In some such embodiments, the latch module may be configured so that it can be commanded to unlatch (e.g. by way of an exit actuator as described later herein) to allow the user to exit the access-controlled area, unless some other provision is made for the user to exit. In other embodiments, the latch module may remain unlatched during a time in which a user is present within the access-controlled area.

In some embodiments, a latch module for use in the arrangements disclosed herein may be a low-power-consumption latch module. By a low-power-consumption latch module is meant that the module uses power at a nominal rate of less than 1.0 W. In further embodiments, the module may use power at a nominal rate of less than 500, 400, 300, 200, 100, or 50 mW. In some embodiments, a low-power-consumption latch module may rely on a latching mechanism that essentially only consumes electric power during the process of actually moving the physical latch (bolt) from an unlatched position to a latched position and vice versa. This may be compared to, e.g., latching mechanisms such as some electromagnets that may constantly draw on electric power to maintain an electromagnetic force to keep a gate in a closed and latched position.

In some embodiments, a low-power-consumption latch module may rely on a so-called latching solenoid lock; for example, a device of the general type described in U.S. Patent Application Publication No. US20190/100941, which is incorporated by reference in its entirety herein, and exemplified by various latching solenoid locks available from TLX Technologies, Pewaukee, WI. Such devices (which may occasionally be referred to as “bistable” solenoid locks) will only consume power during the actual moving of a bolt between latched and unlatched positions while drawing essentially no power when the bolt is stationary in either position.

In some embodiments, a low-power-consumption latch module may rely on a conventional solenoid latch of the “power-on unlatching” type. Such a latch will only draw power during the times that the latch-bolt is being moved to an unlatched position and is held in the unlatched position. (Latches of this type are often used e.g. on entry doors that are equipped with a badge reader that can read a person's badge e.g. via RFID and can then momentarily unlock the entry door.) Such a latch will not draw power while the latch-bolt is in a latched position (in many embodiments, an unpowered (mechanical) biasing element may be used to maintain the latch-bolt in the latched position). Thus, while a power-on unlatching solenoid latch may not exhibit the extreme low-power consumption of e.g. a latching solenoid (bistable) lock, such a latch may still exhibit a power consumption that is sufficiently low to render it very suitable for the present application. In contrast, a “power-on latching” solenoid latch, which would constantly draw power when the latch is in a latched condition, would typically exhibit a much higher power consumption and thus might not be as suitable for such a use.

For purposes of assessing a “nominal” rate of power usage as referred to above, the overall power usage of a latch module, averaged over a suitable long-term time period (e.g. one hour or more) of ordinary use, will be used. By way of a specific example, a latching solenoid lock may operate at e.g. 12V (DC), and may draw a current of up to e.g. 1.5 Amps, corresponding to a power consumption of approximately 20 W. However, this only occurs during the process of actually moving the bolt; the vast majority of the time, the bolt will be stationary and the power consumption will be essentially 0 W. So if an entry gate is unlatched/relatched e.g. 10 times over one hour, with each unlatch/relatch cycle taking approximately 1.0 second, the latch module will only be drawing this power during approximately 0.3% of that hour. Given this in-use duty cycle, and with an average power draw of 20 W during each period of power consumption, the “nominal”, overall power consumption, as averaged over this hour, will be approximately 60 mW. (There will of course be some power usage from the background functioning of the circuitry of the latch module, e.g. to allow the latch module to be able to receive and process any signal emitted by the monitoring system, but such power usage is expected to be negligible in comparison to the power used in actually latching and unlatching the bolt.)

By comparison, a conventional electromagnetic latch may consume e.g. several hundred mA (at e.g. 12V or 24V), with this power consumption typically occurring whenever the gate is closed with the latch in a latched condition. Since a gate to an access-controlled area will likely spend the vast majority of the time in a closed/latched state, the power consumption may thus be quite high. That is, the in-use duty cycle of such an electromagnetic latch may be close to 100%, thus the latch may exhibit a nominal, overall rate of power usage of e.g. several watts. The above-defined terminology of a low-power-consumption latch module as a module that uses power at a nominal rate of less than 1.0 W can thus now be appreciated. This low power consumption means that in some embodiments a latch module 20 as disclosed herein may be powered by an internal power source 22 (e.g. a battery such as a 12V battery) as depicted in generic representation in FIG. 1, rather than by an external power source e.g. via a wired connection. However, in some embodiments a wired connection to an external power source can be used if desired.

In some embodiments, a latch module as disclosed herein may be optionally configured so that the latch module can monitor the position of the physical latch (bolt) and can report any situation in which the bolt does not appear have fully moved to a desired unlatched or latched position in response to a signal or command. Such a capability may allow the latch module to issue a try-again command to the latch, to run a self-check on the latch module circuitry, and/or to provide a notification to a user e.g. to check the condition of the latch.

As referred to briefly above, a latch module may be configured to receive a positive signal from the fall-protection monitoring system. In some embodiments, this signal may be received wirelessly, e.g. from a base unit of a fall-protection monitoring system as described later herein. However, in other embodiments (e.g. if the latch module and a base unit of the fall-protection monitoring system are combined into a single unit that is installed at the entry gate), the latch module may receive such a signal via a wired connection. (Here and elsewhere herein, a “wired” connection broadly encompasses not only e.g. metallic wires, but also fiber-optic cables and the like.)

### Entry Gate

As noted, a latch module 20 as disclosed herein is installed at an entry gate 10 of an access-controlled area 1. By “at” an entry gate is meant at any suitable location that allows the latch module to control the latching/unlatching of the entry gate. Thus a latch module 20 may be positioned on a fixed (stationary) portion of a barrier 11 so that the module 20 can control the position of a movable bolt 21 that interacts with a tang 25 of an entry gate 10. Conversely, the latch module 20 may be positioned on the entry gate 10 and may comprise a bolt that interacts with a tang that is on a fixed portion of the barrier. Still further, a latch module might be positioned e.g. on a floor adjacent the bottom of the entry gate, or may extend from some item that is positioned above a portion of the entry gate. Any such arrangement is possible as long as the latch module can control the entry gate in the general manner disclosed herein.

In some embodiments a latch module (or at least some components thereof) may be installed when a stationary barrier and/or entry gate are originally manufactured. In other embodiments, a latch module may be installed, e.g. retrofitted, on an existing barrier and gate. A latch module may be mounted e.g. onto a fixed portion of an existing barrier by any suitable method of attachment. Similarly, a tang that is configured to work in cooperation with the bolt of the latch module may be mounted on an existing entry gate, again by any suitable attachment method. In some embodiments a latch module may be provided in such form (e.g., accompanied by suitable hardware) to render it retrofittable onto a variety of existing barriers and gates. Thus in some embodiments a latch module may be provided in a “universal mount” form as needed to allow the latch module to be readily installable onto a variety of barriers and gates without having to substantially modify the barrier or gate. It will be appreciated that in some such embodiments the latch module will, strictly speaking, include a tang that is retrofitted to an entry gate or fixed barrier.

As noted above, in some embodiments a latch module may be battery powered. It will thus be appreciated that in some embodiments a latch module may be easily retrofitted onto an existing barrier and entry gate, without requiring running an electric power line to the latch module and without requiring substantial structural modification (e.g. welding) of the barrier and/or gate.

Any suitable entry gate and an associated fixed barrier can be fitted with a latch module. The term gate is used broadly, to encompass any entity or collection of entities that, when “closed”, substantially prevents a person from walking into an access-controlled area; and, that is movable to an “open” position that allows the person to walk through the opened gate into the access-controlled area. In some embodiments a gate may be of the general type embodied by gate 10 of FIG. 1; that is, with a body comprised of a set of members (e.g. vertical columns and horizontal bars). In other embodiments, a gate body may be solid over some or all of its major area rather than comprising members with spaces therebetween.

Regardless of the specific design, in some embodiments a gate may comprise a body that is connected to a fixed portion of a barrier 11 by one or more hinged connections 12 so that the gate is pivotally openable. In some embodiments, such a gate may be biased toward a closed position (e.g. by way of a biasing means 13 in the form of a spring located at or near a hinged connection). This can provide that the gate will automatically swing back shut after a user has gone through the opened gate.

In some embodiments, an entry gate may comprise one or more secondary latches that may be separate from, and operate independently of, the herein-disclosed latch module. In some embodiments, such a secondary latch may be a mechanical latch. Thus in some embodiments, to pass through an entry gate a user may unlock a secondary mechanical latch and may connect a connector 30 to the user's harness thus causing latch module 20 to unlatch as described herein, after which the user can open the gate. In some embodiments, such a secondary mechanical latch may serve primarily or solely to provide a secondary way of keeping the gate closed. Such a secondary mechanical latch might be quite simple, e.g. a slide-bolt or crossbar latch, a cabin-hook latch, or the like. In other embodiments, a secondary mechanical latch may provide an additional layer of access control; in such cases the secondary latch will be termed a “lock”. For example, such a lock might be a key-operated lock that can only be unlocked by an authorized user in possession of an appropriate key. Similarly, in some embodiments a secondary lock may be electronic, e.g. comprising a keypad and only unlocking if a proper code is entered. Or, an electronic lock may comprise a badge reader that reads information from a user's badge (e.g. via RFID) and determines whether the user is authorized to enter the area, before unlocking.

In some embodiments, a secondary latch or lock may have a physical bolt that is biased toward the latched position and that comprises an angled edge so that upon impinging on an entity (e.g. on a tang or a strike plate) the bolt momentarily retracts from the latched position and then returns to the latched position after the bolt has passed by the entity. Such a secondary latch or lock may thus be automatically self-latching in an easily understood manner. (Although not discussed above, a bolt of a herein-disclosed latch module may, in some embodiments, be automatically self-latching in this manner.) Many variations of the above arrangements are possible. In some embodiments the interlocking system may be configured so that a positive signal causes the latch module to unlatch the entry gate, with the user then manually pushing the gate open to enter. In some embodiments the interlocking system may be configured so that a positive signal causes the latch module to unlatch the entry gate and to open the entry gate (e.g. via a pneumatic actuator). In various embodiments, an entry gate may pivotally open outward, or inward; or, an entry gate (or portions thereof) may slide sideways, upward or downward to open. In some embodiments, an access-controlled area may have multiple entry gates (e.g. two, three, or more); each such entry gate may have a dedicated latch module with each latch module being in communication with a single fall-protection monitoring system. Or, multiple fall-protection apparatus and/or monitoring systems may be present. Any such arrangement is permitted, as long as it is in compliance with all applicable laws, rules, codes, standards, and so on.

In some embodiments an entry gate may be equipped with an entry gate sensor module comprising one or more sensors that can ascertain whether the entry gate is in a fully closed position, or is open at least partway. In some such embodiments, the entry gate sensor module may provide this information to the fall-protection interlocking system (in other words, the entry gate sensor module may function as part of the interlocking system). An entry gate sensor module may thus send a signal to the latch module and/or to a base unit of the fall-protection monitoring system. Any such signal sent by an entry gate sensor module will be termed an auxiliary signal (e.g. a “closed” or “open” auxiliary signal), to distinguish it from the aforementioned positive signal that will be sent e.g. from a base unit of the fall-protection monitoring system.

In some embodiments, one or more additional safety apparatus (other than the fall-protection safety apparatus) may be installed at or near the access-controlled area. One such additional safety apparatus may be a user authorization module that (e.g. by scanning an RFID tag, barcode, NFC code or QR code of a person's badge) can confirm that a person who seeks to enter the access-controlled area is authorized to enter the area. Thus for example, a user authorization module (e.g. a badge reader) 15 may be provided e.g. at or near an entry gate in the general manner illustrated in FIG. 1. In some embodiments, the interlocking system may rely on a signal from such an authorization module; such a signal (e.g. an “authorized” or “not authorized” signal) will be termed a secondary signal to distinguish it from a previously-described positive signal that is emitted by the fall-protection monitoring system.

In some such embodiments, the latch module may need to receive a positive signal from the fall-protection monitoring system, and to also receive a secondary positive (i.e., an “authorized”) signal from a user authorization (e.g. badging) module, in order to unlatch the entry gate. It will thus be appreciated that in some embodiments, an interlocking system that governs access to a particular area may be configured so that a person must be connected to a fall-protection apparatus, and must be identified as an authorized user in order for the system to allow the person to enter the area. In some instances, such an authorization module may be combined with latch module 20 (e.g., it may take the form of a badge reader that is provided on or within a housing of the latch module is disposed).

The above is a specific example of a general case in which an interlocking system may require multiple signals (a positive signal from the fall-protection monitoring system, and a secondary positive signal e.g. from an authorization module) in order to allow entry. If an access-controlled area is equipped with additional safety apparatus, one or more additional signals may be used in similar manner. Again, numerous variations are possible. For example, an authorization module may rely on a keypad that accepts a passcode, rather than reading a user's badge. And, as noted above, in some embodiments a user authorization system may operate in conjunction with a secondary lock that is separate from, and operates independently of, the fall-protection monitoring system and the latch module.

An interlocking system as disclosed herein can be configured or arranged in various ways in terms of the state the entry gate is put into, and/or maintained in, after a user has entered through the gate. As noted, in many cases the entry gate will be biased (e.g. by a biasing system that operates independently of the latch module) to return to a closed position after the person has entered. This may be enabled e.g. by a spring-biasing system that closes the gate as soon as the user is no longer applying force to hold the gate open; or, a pneumatic or electronic system may be used that closes the gate e.g. after a suitable time period or after a proximity sensor has detected that the user has moved further into the access-controlled area so that the entry gate can be closed. Once the gate has closed, the latch module may relatch or may remain unlatched, depending on how the system is configured. In some embodiments, choices such as this may be user-configurable (noting again that any such configuration must be in compliance with all applicable laws, rules, codes, standards, and so on).

In some embodiments, after the user has entered, the latch module may remain unlatched (although, as noted, the entry gate may comprise a separate, e.g. mechanical, secondary latching system). In such a case, in order to subsequently exit the area the user merely needs to open the entry gate and exit through the gate. No further interaction with the fall-protection monitoring system or the latch module is needed for this (although the user may still need to unlatch a secondary mechanical latch to exit). Upon the user having exited the gate and disconnected the connector from his or her harness (and the gate having been automatically reclosed or manually reclosed by the user), the interlocking system, having ceased to receive a positive signal from the fall-protection monitoring system and/or having received a negative signal from the monitoring system, will relatch the entry gate into its normally-latched condition. Such a configuration may be suitable in certain instances, e.g. a case in which according to work rules, only a single person is to be within a particular access-controlled area.

In some embodiments the latch module may be automatically relatched (e.g. after a suitable time period has passed, e.g. 10-30 seconds) after a user has entered through the gate and the gate has reclosed, and may remain in the relatched state while the user is present in the access-controlled area. Or, if a signal is received from a gate sensor (discussed in detail elsewhere herein) that the gate has been closed, the latch module may then relatch. In any such embodiment, provision may be made to unlatch the entry gate at a desired time so that the user can exit the access-controlled area. In some embodiments, an exit actuator (e.g. a button or switch) 70 may be provided within the access-controlled area; in some embodiments, any such exit actuator 70 may be located so that it cannot be reached from outside the access-controlled area. In the exemplary depiction of FIG. 1, an exit actuator 70 is situated on a stanchion 71; however, such an actuator, if present, can be at any suitable location, e.g. mounted on any suitable structure or support.

In some embodiments, such an actuator may be positioned on latch module 20 (e.g., it may take the form of a button or switch that is provided on a housing within which the latch module is present). In some such embodiments (in general, for any exit actuator that is positioned so that it can be reached from outside the access-controlled area), such an actuator may be passcode-protected e.g. so that a user must enter a proper exit code to unlatch the gate. As noted above, in some embodiments a badge reader may be provided e.g. on or near the latch module; in some such embodiments, the badge reader may function as an exit actuator so that a user who is in the access-controlled area with the latch module in a latched condition, may merely place his or her badge near the badge reader to cause the latch module to unlatch. In such an arrangement, this functionality may be interlocked with the fall-protection monitoring system so that the badge reader can only unlock the latch module if the monitoring system detects that the connector of the fall-protection apparatus appears to be connected to the user's harness.

Any such exit actuator, of any design, can be configured so that it can be actuated by the user to send an actuation signal to the latch module, such that upon receipt of the actuation signal the latch module unlatches the entry gate. It will be appreciated that in many embodiments it may not be useful to locate an exit actuator on a housing 51 of fall-protection apparatus 50, since such a housing will often be located overhead in a position in which it is not easily reachable. However, in some embodiments, an exit actuator may take the form of a mechanical command interface of a specially-configured fall-protection apparatus. In such embodiments, a mechanical command interface may comprise one or more sensors that can detect mechanical command signals in the form of purposeful manipulations of the safety line of the fall-protection apparatus by the user of the apparatus. Thus for example, a fall-protection monitoring system may send an “exit” signal to the latch module to unlatch the gate, upon a mechanical command interface of the monitoring system detecting purposeful manipulations of the safety line (e.g., three extensions/retractions of the safety line in quick succession) that are recognized by the interface as collectively providing an exit command. Such arrangements, and ways to configure a fall-protection apparatus to facilitate such arrangements, are discussed in detail in U.S. Patent Application Publication No. 2020/0101330, which is incorporated by reference in its entirety herein. Such a mechanical command interface may comprise a set of recognized commands for use for any suitable purpose, e.g. to cause the latch module to relatch the gate, to issue a notification, and so on.

In some embodiments, an exit actuator may be located on connector 30 itself, e.g. in the form of a push-button or switch provided on a molded shroud that encompasses a portion of the connector. In some embodiments, the connector may be configured so that purposeful manipulation of one or more components of the connector provides a command interface that serves as an exit actuator. In some embodiments an exit actuator may be located on a harness worn by an authorized person who enters the access-controlled area.

In some embodiments an interlocking system as disclosed herein may comprise an override mode of operation that allows a person (e.g. a first responder) to enter the access-controlled area. In some embodiments, such a mode may rely on an override actuator 23 that can be actuated to cause the latch module to unlatch e.g. regardless of the state of the connector of the fall-protection apparatus. In some embodiments, such an override actuator may be configured (and work rules may be implemented) so that the override actuator is not to be accessed or used other than in specific circumstances. Thus for example an override actuator may take the form of a button or switch that is behind a barrier that must be broken in order to access the actuator. Or, an override actuator may take the form of a keyed system akin to the keyed systems of elevators that allow for firefighter operation. (If a secondary locking system is present, an override actuator may be configured so that it unlocks they secondary locking system as well.) In some embodiments, an override actuator 23 may be located on the latch module as indicated in FIG. 1. However, in general, an override actuator may be at any location at which it can be accessed and actuated by a person, e.g. a first responder, located outside the access-controlled area. Any such override actuator, of any design, can be actuated to send an override signal to the latch module, such that upon receipt of the override signal the latch module unlatches the entry gate.

In some embodiments, a user may not necessarily need to exit an access-controlled area 1 through an entry gate 10 through which the user entered the area. For example, in some embodiments an access-controlled area may be equipped with an exit that is separate from the entry gate. In some embodiments such a gate may be equipped with a turnstile or like mechanism that allows exit but does not allow entry. If such an arrangement is used, the exit-only gate may be located and configured so that the user can reach and exit the gate while still connected to the fall-protection apparatus, after which the user should be able to return the distal end of the safety line of the apparatus to a location at which it is reachable from a position outwardly proximate the entry gate.

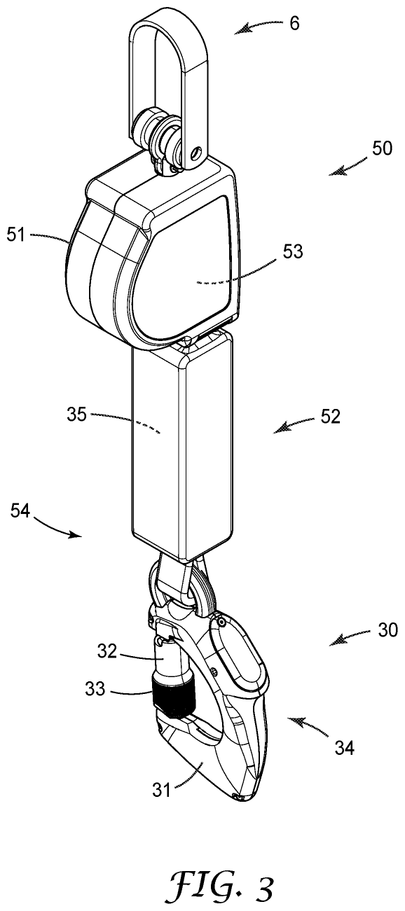

Fall protection apparatus A fall-protection interlocking system as disclosed herein will rely on at least one fall-protection apparatus 50 as disclosed herein. As shown in exemplary embodiment in various Figures, such a fall-protection apparatus 50 may be used as part of a fall-protection system that includes a harness 40 configured to be worn by a human user of an area that is access-controlled due to a fall risk. Fall-protection apparatus 50 will comprise a safety line 52 (which may take the form of e.g. a metal cable, a DYNEEMA webbing, and so on), a distal end of the safety line being equipped with a connector 30 configured to be connected to the harness 40. (Other components may be present as well, as will be well understood by artisans in the field.) A connector 30 may be referred to herein by the generic terminology of “hook” or “gated hook”; however, it will be understood that some such connectors are often referred to as carabiners, with there not necessarily being a firm dividing line between the two. Many such hooks and carabiners (as illustrated in further detail in exemplary embodiment in FIGS. 3 and 4) will comprise a hook body 31 and a movable gate 32 and thus will be termed a gated hook. In at least some embodiments, any such connector will be compliant with ANSI standard Z359.12-2019. In some embodiments a connector may be a double-action connector (i.e. with a gate that requires at least two consecutive, different actions to open). One category of double-action connectors are so-called twist-lock hooks and carabiners of the general type exemplified by the product available from 3M Fall Protection under the trade designation KJ5108 HOOK CONNECTOR and various connectors available from 3M Fall Protection under the trade designation SAFLOK. In such connectors, a locking mechanism (e.g. a collar or partial collar 33 as illustrated in FIG. 3) of the gate of the connector must be twisted (e.g. at least a quarter turn, around an rotation axis aligned with the long axis of the gate) in order to unlock the gate so that it can then be opened. In various embodiments, such a locking mechanism may be e.g. a collar fitted on a portion of the gate; or, the entirety of the gate may be twistable. Some such double-action connectors (e.g. products available from 3M Fall Protection under the product numbers 2000300 and 2000301) are actually triple-action connectors in which the gate must be moved slightly along its long axis before it can be rotated to allow the gate to be opened. Another category of double-action connectors are so-called snap hooks (or locking snap hooks) in which a locking mechanism must be moved (e.g. pressed inward or squeezed) before the gate of the hook can be opened. Such connectors include those available from 3M Fall Protection under the products numbers 2007153 and 9510057. All such items will be considered to be connectors as defined herein, and may be referred to generically as gated hooks.

In many embodiments a connector 30 of a safety line 52 may be configured to be connected to a harness 40 by being attached to a D-ring that is non-removably mounted on the harness. In particular embodiments the connector may be attached to a dorsal D-ring 41 of the general type illustrated in FIG. 4. It is noted that the term D-ring generically encompasses any metal item that is attached to a fall-protection harness and is configured to have a connector of a safety line attached thereto. Such an item does not necessarily have to exhibit any specific shape; in particular, such an item does not need to be strictly D-shaped. In some embodiments, a connector may be configured to be used as part of a matched pair of connectors (e.g. one on a safety line and one on a harness; or, on ends of first and second straps, lines or the like) that are specifically configured to be mateable or otherwise engageable with each other but not to be mateable to other types of connectors. In some embodiments such connectors include modular connectors of the general type described in the 3M DBI-Sala Fall Protection Full-Line Catalog 2017 as being supplied as components of Modular Lanyards such as e.g. the EZ-STOP MODULAR LANYARD.

Such connectors may, for example, comprise a design in which a female connector comprises a generally T-shaped slot configured to accept a generally T-shaped bar of the other, male connector. In many embodiments, such connectors may be lockable when engaged so that they cannot be disengaged from each other without a prior, purposeful manipulation that places them into an unlocked condition in which they can be disengaged from each other. In some embodiments, such connectors include so-called quick connectors of the general type supplied as a component of e.g. the 3M DBI-SALA NANO-LOK Self-Retracting Lifeline, quick-connect buckles of the general type supplied as a component of e.g. the 3M DBI-SALA EXOFIT STRATA Harness, and the like.

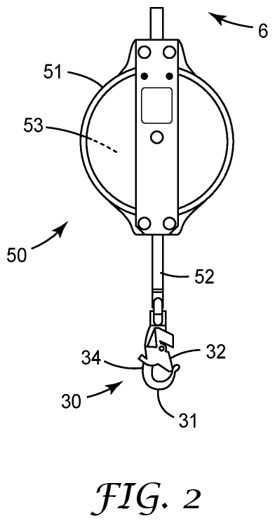

In many embodiments, fall-protection apparatus 50 may be a so-called self-retracting lifeline (“SRL”) as shown in exemplary embodiment in FIGS. 1-3. Ordinary artisans will understand that a self-retracting lifeline comprises a load-bearing safety line (“lifeline”) 52 that can be unwound from a housing 51 which may be secured to an anchorage 6 located e.g. on a support structure 5. A distal end of safety line 52 is connectable, e.g. by way of a connector (e.g. a gated hook) 30, to a D-ring 41 of a harness 40. SRL housing 51 comprises a reel (drum) 53 (indicated generically in FIG. 3) that is rotatably connected to housing 51, with a proximal end of safety line 52 being attached to reel 53. Safety line 52 can be unwound from reel 53 and thus extended from housing 51 to follow a user as the user moves about, with reel 53 being biased so that the reel retracts safety line 52 back into housing 51 and rewinds it onto reel 53 as the user moves toward housing 51. Some such SRLs (e.g. housing 51 and reel 53 thereof) may include a brake, e.g. comprising centrifugally-activated pawls that act in cooperation with a friction pad or the like, that is triggered in the event of a user fall (e.g. upon rapid unwinding of safety line 52 from reel 53) to safely bring the user to a halt. Some such SRLs may feature a safety line 52 that is equipped with an energy absorber 35 (as denoted in FIG. 3) in the form of a so-called tear-strip or shock-pack. Such energy absorbers often rely on several segments of safety line, e.g. webbing, that are accordion-folded together and sewn to each other so that they can “unzip” from each other in a manner that absorbs energy in the case of a fall.

Fall-protection apparatus such as self-retracting lifelines and components and functioning thereof are described in various aspects in U.S. Pat. Nos. 7,843,349, 8,256,574, 8,430,206, 8,430,207, and 9,488,235. In some embodiments a self-retracting lifeline will meet the requirements of ANSI Z359.14-2014. Any such fall-protection apparatus 50, e.g. a self-retracting lifeline, will be configured to allow a user who is within access-controlled area 1 to move about the area and perform actions as needed.

As noted earlier herein, a fall-protection apparatus 50 (specifically, a housing 51 thereof) will typically be attached to an anchorage 6 at a location that is generally overhead the access-controlled area 1. An anchorage 6 is typically attached to, or is a part of, a support structure 5 that is capable of bearing the forces that may develop e.g. in the event that the fall-protection apparatus performs a fall-arrest of a user. Such a support structure may be e.g. an existing beam or strut of a structure. In some instances, the support structure may take the form of a generally upwardly-extending mast whose lower end is attached to some structural item (e.g. to a “floor” of the access-controlled area) and that is configured to provide an overhead anchorage for the fall-protection apparatus.

As noted, the fall-protection apparatus 50 will be configured so that the distal end 54 of the safety line 52 of the fall-protection apparatus is reachable and graspable (e.g. with the hand) by a user when the user is at a location 2 that is outwardly-proximate the entry gate 10. In some embodiments, the fall-protection apparatus may be positioned generally above entry gate 10 (e.g. in the general manner shown in FIG. 1) so that the user can, while standing at position 2, simply reach up and grasp the connector 30 of the apparatus. Such an arrangement, in which the housing of the fall-protection apparatus is e.g. in a fixed position relative to the entry gate, may be adequate for many situations, e.g. if the access-controlled area is sufficiently small and the fall-protection apparatus has a safety line that is sufficiently long and/or extendable.

However, in other embodiments the housing of the fall-protection apparatus may be movable relative to the entry gate; that is, it may be attached to an anchorage that is movable throughout at least some of the extent of the access-controlled area. In such embodiments, a fall-protection apparatus (e.g. a self-retracting lifeline) may comprise a housing that is attached to an anchorage that is disposed on a swing-arm that is movable through an arc. Or, the housing may be attached to an anchorage that is in the form of a carriage that can move along a generally horizontal track (e.g. a rail or cable) thus allowing movement in one direction. In some embodiments, a track to which the housing is attached may be a primary track or bridge that is mounted to one or more secondary tracks along which the primary track can move, thus allowing movement in two general directions. Various arrangements and combinations of such arrangements are possible, e.g. the products generally termed trolley anchors available from 3M Fall Protection; and, any of various systems available from Engineered Fall Protection, Bridgeton, MO, under the trade designation TETHER-TRACK. Any such arrangement can allow a housing of a fall-protection apparatus to be “parked” at a location at which the connector at the distal end of the safety line of the apparatus is reachable by a user who is outside the entry gate, and can further allow the housing to be moved about within the access-controlled area in order to allow the user to move about the area as needed.

In some embodiments, a housing 51 of a fall-protection apparatus 50 will be positioned, and/or the safety line 52 of the apparatus will be extended, so that a user who is outside the entry gate can grasp the connector at the distal end of the safety line, directly. In some embodiments, a safety line 52 of a fall-protection apparatus may be equipped with an additional “leader” line (sometimes referred to as a tagline) to facilitate the grasping of the connector by a user who is outside the entry gate. Such a leader line may take the form of e.g. a lightweight rope or twine that is connected to the distal end of the safety line and is long enough to reach a location (e.g. outwardly-proximate the entry gate) where the leader line can be grasped by the user. The user can then gently pull on the leader to extend the safety line sufficiently far that the user can now grasp the distal end of the safety line. Some such arrangements may make use of a tagline that is powered and/or remote-controlled, e.g. as with the product termed 3M DBI-SALA Remote Power Tagline. All such arrangements are encompassed within the concept of a distal end of a safety line being graspable by a user.

In some embodiments, a connector 30 of a fall-protection apparatus 50 may simply hang loose (whether near the housing 51 of the fall-protection apparatus, or with the safety line extended at least somewhat away from housing 51) when the apparatus is not in use. In some embodiments, a fall-protection system can optionally include a docking station 14 to which a connector 30 at a distal end of a safety line 52 can be docked (i.e., connected) when not connected to the harness of a user. In some embodiments, a feature (e.g. a beam or strut) of barrier 11 or of gate 10 may serve as a docking station. In other embodiments, a docking station may take the form of a dedicated item that is installed for this purpose. For example, a docking station 14 may be installed on barrier 11 in the general manner shown in exemplary embodiment in FIG. 1. Any such docking station 14 should be positioned so as to be easily accessible by a user that is outwardly-proximate the entry gate 10. In some embodiments, such a docking station may be made of materials that will not be detectable by a sensor module of the connector, e.g. so that the fall-protection monitoring system can distinguish between the connector being connected to a harness and being parked on the docking station. For example a D-ring of a harness may be made of a metal such as steel so that the sensor module can detect it, while a docking station 14 may be made e.g. of molded plastic so that the sensor module does not register the presence of the docking station.

In various embodiments, any such docking station may be integrated with a base unit 65 (described in detail later herein) of the fall-protection monitoring system, may be integrated with a housing of the latch module 20, or may be a separate entity from both. In some embodiments a docking station may be a purely mechanical apparatus that does not participate, either actively or passively, in the fall-protection monitoring system. In other embodiments a docking station may be configured (e.g. equipped with a docking-station sensor module) to participate in the fall-protection monitoring system. That is, such a docking station may be able to detect that the connector is docked on the station and may communicate this information to the fall-protection monitoring system, so that the system can additionally distinguish between a case where the connector is connected to a user's harness and a case where the connector is docked on a docking station.

A fall-protection interlocking system as disclosed herein will comprise a fall-protection monitoring system 60 configured to determine whether the connector 30 of the safety line 52 of the fall-protection apparatus appears to be connected to a safety harness 40 (e.g. to a D-ring 41 of the safety harness) worn by a user who desires to enter an access-controlled area 1. The fall-protection apparatus 50 and the safety harness 40 may thus combine to form a fall-protection system. However, these items need not stay together at the access-controlled area at all times; for example, a fall-protection apparatus such as an SRL may reside and remain at the access-controlled area, while a safety harness may be worn by the user even while the user is disconnected from the SRL and is away from the access-controlled area.

A fall-protection monitoring system of a fall-protection apparatus may, in some embodiments, comprise at least one sensor module and at least one base unit, as discussed in detail later herein. Any such fall-protection monitoring system will be configured so that if the monitoring system determines that the connector appears to be connected to the safety harness, the fall-protection monitoring system will issue a positive (e.g. ready) signal that can be received by the latch module. A positive signal that is issued by the fall-protection monitoring system of the fall-protection apparatus indicating that the connector appears to be connected to the safety harness (i.e., that the fall-protection apparatus is in a ready condition), may in some instances be termed a “first” positive signal to distinguish it from any additional signals described herein (e.g. a secondary signal issued by a user-authorization system, an auxiliary signal issued by a gate-sensor module, etc.)

Interlocking of Access-Controlled Area with Fall-Protection Apparatus

As disclosed herein, an access-controlled area 1 is interlocked with the fall-protection apparatus 50. By this is meant that in order for an entry gate into the area to be unlatched, a latch module with which the gate is equipped must receive (at least) a first positive signal from the fall-protection monitoring system indicating that the connector of the safety line appears to be connected to the safety harness of the user. Depending on how the system is configured, the fall-protection monitoring system may or may not ever issue a negative (not ready) signal indicating that the connector of the fall-protection apparatus does not appear to be connected to the harness of the user. That is, in some embodiments, the latch module may take action (or, strictly speaking, may refrain from taking an action such as unlatching the entry gate) based on the absence of a positive (ready) signal from the fall-protection monitoring system. In other embodiments, the fall-protection monitoring system may actually issue a negative (not ready) signal that is received by the latch module.

In some embodiments, a fall-protection interlocking system as disclosed herein may serve primarily, or solely, to cause an entry gate to an access-controlled area to be latched or unlatched depending on whether a connector of a fall-protection apparatus is connected to the user's harness (and, in some embodiments, depending on at least one other factor, e.g. whether the user has been identified as an authorized user of the area). However, in some embodiments, the system may perform one or more additional functions. For example, the interlocking system may additionally serve to issue one or more notifications. Such a notification may be e.g. a warning notification in the event that the connector is detected as not appearing to be connected to the user's harness, or a ready notification if the connector is detected as appearing to be connected to the user's harness.

In some embodiments, the system may issue a specific notification in particular circumstances. For example, if the fall-protection monitoring system detects that the connector appears to have become disconnected from the user's harness, and the system further detects (e.g. by way of an entry-gate sensor or a latch sensor) that the entry gate does not appear to have been opened to allow the user to exit, the system may issue a special notification that the user appears to be disconnected from the fall-protection apparatus while within the access-controlled area. Various other notifications may be issued in particular circumstances.

By a notification is meant a signal that is intended for any or all of the user of the access-controlled area, one or more persons in the local surroundings, and one or more designated persons e.g. at a monitoring station. Such notifications may take the form of e.g. audible, visual, and/or haptic/tactile notifications and may be issued locally (e.g. by way of lights or buzzers in or near the access-controlled area) and/or may be transmitted e.g. to a smartphone or to a monitoring station. Such a notification may take any suitable form, e.g. green light that illuminates when the monitoring system indicates that the fall-protection apparatus is in a connected, “ready” condition; a red light that illuminates when the monitoring system indicates that the fall-protection apparatus is not in a ready condition; a set of red and green lights; a display screen that indicates a ready or not ready indication, and so on. In particular embodiments, a latch module as located at an entry gate may comprise a display screen which may, for example, display a notification such as Please Connect, Gate Unlatched, and so on, depending on the status that the monitoring system reports.

In some embodiments, a fall-protection monitoring system of a fall-protection apparatus (e.g. an SRL) may comprise a base unit 65 and at least one sensor module 34, the sensor module being configured to sense whether the connector appears to be connected to the safety harness and to communicate connector status information to the base unit. Such a sensor module may thus comprise at least one sensor to sense the condition of the connector, and a communication module that transmits this information (whether wirelessly, or by a wire or fiber optic cable) to the base unit. The base unit comprises a receiving module that can receive information from one or more sensor modules, and a transmission module that, based on the information received from the sensor module(s), can issue the aforementioned (first) positive signal to be received by the latch module 20. In some embodiments, a base unit may also comprise a notification module to emit or otherwise broadcast a notification as mentioned above.

In some embodiments the base unit may receive raw (or partially processed) data from one or more sensors of the sensor module and may perform any or all actual processing that is needed to ascertain the condition of the connector. In other embodiments, the raw data may be at least partially processed by circuitry that is resident within the sensor module itself. In at least some such cases, the base unit need only receive yes/no information from the sensor module that indicates whether the connector appears to be connected or not; and, depending on the information, can send a positive signal to the latch module.

In some embodiments, a sensor module 34 of a fall-protection monitoring system may be installed at a connector (e.g. a gated hook) 30 at a distal end of a safety line 52 of a fall-protection apparatus. Such terminology encompasses arrangements in which the sensor module is located on the connector or is located proximate the connector (e.g. mounted on safety line 52 or on a protective shroud located thereon) as long as the sensor module is close enough to the connector to allow the condition of the connector to be successfully monitored, e.g. to evaluate whether the connector appears to have been attached to a D-ring. In some embodiments, a sensor module 34 may be installed within a housing (e.g. a molded plastic housing) that is fitted over at least a portion of connector 30, in the general manner depicted in FIG. 3.

In some embodiments, a sensor module may be installed on a harness 40 to which connector 30 is to be attached. For example, a sensor module may be installed at a D-ring (e.g. a dorsal D-ring 41) that is non-removably attached to harness 40. Such terminology encompasses arrangements in which the sensor module is located on the D-ring or is located proximate the D-ring (e.g. on a strap or a dorsal plate of harness 40) as long as the sensor module is close enough to the D-ring to allow the sensor of the sensor module to evaluate whether a connector appears to have been attached to the D-ring. The arrangements disclosed herein thus encompass, for example, configurations in which a connector is monitored for an indication as to whether the connector appears to have been attached to a D-ring, as well as arrangements in which a D-ring is monitored for an indication as to whether a connector appears to have been attached to the D-ring.

Other arrangements are possible. In some embodiments a sensor module may be located at a docking station that is configured to accept connector 30 when connector 30 is not connected to the user's harness (such docking stations were discussed in further detail earlier herein). In embodiments in which the fall-protection apparatus is a self-retracting lifeline (SRL) 50, the SRL may comprise a sensor module that is configured to monitor the position of connector 30 relative to the housing 51 of the SRL. Such a sensor module might comprise e.g. a sensor that is on the housing and that is configured to ascertain whether connector 30 is in close proximity thereto. Or, such a sensor module might comprise a sensor that is configured to determine the distance to which safety line 52 has been paid out from housing 51 (such a sensor might be, for example, a rotary encoder that tracks the rotation of reel 53 to which the proximal end of safety line 52 is attached). Such a sensor module may thus be configured to provide an indication of, for example, whether connector 30 is snugged up tight against the SRL housing or is proximate (meaning within 0.2 meters of) the housing; or, whether connector 30 has been paid out a considerable distance (e.g. more than 0.2 meter) from the housing. Such information can be used, if desired, as an indication of the condition of the connector. For example, if the connector is reported to be snugged tight against the SRL housing, this may be inferred to be an indication that the connector does not appear to be attached to a harness of a user.

The discussions above make it clear that a sensor module may be installed e.g. at a connector (e.g. a gated hook), at a harness D-ring to which the connector is to be attached, at a docking station to which the connector can be docked when not in use, or at an SRL housing from which a safety line bearing the connector can be extended. Any such arrangement, and any desired combination of such arrangements, is encompassed within the disclosures herein.

A base unit 65 of the fall-protection monitoring system 60, that receives information from the sensor module(s) 34 indicative of the condition of the connector, can be positioned in any suitable location. In some embodiments, a base unit 65 may be installed at a chosen location in or near the access-controlled area, e.g. as with exemplary base unit 65 as shown in FIG. 1. In some embodiments, a base unit may be installed at the connector of a safety line (e.g. the base unit may be co-located with a sensor module that is on or proximate a hook). In some embodiments, a base unit may be installed on the harness, e.g. at a harness D-ring. In such embodiments, the base unit may be co-located with a sensor module that is installed at the D-ring and may receive signals therefrom; or, the base unit may be installed on the harness but may receive signals from a sensor module that is installed at the connector rather than at the D-ring. In some embodiments, a base unit may be installed at, on, or within a housing of a self-retracting lifeline. In some embodiments, a base unit 65 may be co-located with the aforementioned latch module 20; e.g., the circuitry and components that collectively constitute a base unit 65, and the circuitry and components that collectively constitute a latch module 20, may be located within a common housing. In some embodiments, beyond simply being physically located within the same housing, the electronic components that make up base unit 65 and those that make up latch module 20 may be functionally integrated with each other, e.g. sharing one or more components (circuit boards, signal processors, etc.) in common. In similar manner to latch module 20, a base unit 65 may be supplied by an external power source or may rely on an internal power supply such as a battery.

As noted, a fall-protection monitoring system 60 will comprise at least one sensor module 34. The term sensor module is used in general to describe a device that comprises at least one sensor that performs any actual sensing required, a processor that includes a communication module to send the information gathered by the sensor to a base unit, and all necessary hardware, software, power sources (e.g. a battery) and so on, to operate the sensor(s), the communication module, and so on. A sensor module 34 may e.g. be partially or wholly encompassed within a housing, e.g. a molded plastic housing, which housing may be e.g. attached to or otherwise disposed on a connector (in the general manner depicted in FIG. 3) or on a D-ring. In some embodiments the sensor module may be attached e.g. to a safety line or a shroud thereon, or to a component (e.g. a strap or a dorsal plate) of a harness, as long as the sensor of the sensor module is positioned in a location that allows it to perform its desired function.

In some embodiments, a sensor of a sensor module may be configured to detect metal. This may be useful since many connectors (e.g. hooks/carabiners) and D-rings are made of metal such as steel or the like. Thus, a sensor located at a D-ring or docking station may be able to detect the presence of a metal connector; conversely, a sensor located at a connector may be able to detect the presence of a metal D-ring. In particular embodiments, any such sensor may be configured to particularly detect a metal item or a portion thereof that is positioned within, or close to, an opening defined by the entity at which the sensor is installed. For example, a connector (e.g. a gated hook) may be equipped with a sensor module whose sensor or sensors are configured to detect a portion of a metal item (e.g. a D-ring) that is within the opening defined by the hook.

In some embodiments such a sensor may rely on magnetic sensing. In some embodiments such a sensor may rely on inductive sensing. In some embodiments of this type, such a sensor may interrogate and monitor changes in a resonant frequency of an electronic circuit of an inductive sensor (which changes may result e.g. from eddy current phenomena that is generated when a metal item is brought into an inductive field). Inductive sensing in general, and leveraging of eddy current phenomena in particular, are discussed in detail in U.S. Provisional Patent Application No. 62/628,720, and the resulting International (PCT) application published as WO2019/157007, both of which are incorporated by reference in their entirety herein. It will be appreciated that many of the principles, arrangements and methods disclosed in these documents may be useful for purposes of the present application.

Although discussions above have primarily concerned sensing of metal items, e.g. by inductive sensing, it will be appreciated that any sensor, relying on any sensing mechanism, may be used to sense whether an item is present in an opening defined by the hook. In various embodiments, such a sensor may be any kind of electromechanical sensor, e.g. a load cell that can detect whether the hook has been placed under load. In some embodiments, such a sensor may be an RFID or NFC reader that is configured to detect an RFID or NFC tag or beacon that is present on or in the item (e.g. a D-ring, a docking station, etc.) that the hook is to be connected to.

In some embodiments, at least one other sensor, operating by any sensing mechanism and provided in any particular location and/or applied to any particular step or operation in the use of connector 30 or of the fall-protection apparatus in general, may be used. Such a sensor may operate by some other mechanism than detecting whether an item is present in the opening defined by the hook. While in some embodiments such a sensor may be used in place of the above arrangements, in many advantageous embodiments such a sensor may be used in combination with the above-described arrangements. For example, in some embodiments a hook may be provided with a gate sensor that can monitor the status of a gate of the connector. (In this connection, a “gate” 32 of a connector 30 will be distinguished from an entry gate 10 to an access-controlled area. The terminology of a “hook-gate” will not be used at all times, but it will be clear from the context which is meant.) Such a sensor may be used e.g. in combination with any of the other sensors described herein. For example, in some embodiments one or more first sensors may be used that are inductive sensors configured to determine whether a metal item (e.g. a metal D-ring) is present in the opening of the connector; and one or more second, (hook-)gate sensors may be used to monitor the status of a gate of the connector.

Any such indication provided by a hook-gate sensor will fall under the general category of reporting whether the gate is “secured” or “unsecured”. In some embodiments it may not be that, for example, a gate of a hook must actually be in an open position to be reported as “unsecured”. Rather, the gate of the hook may merely be e.g. unlocked. For example, a connector may be a double-action connector of the general type noted earlier, for example a “twist-lock” hook in which a locking mechanism of the gate of the hook must be rotated slightly in order to unlock the gate so that it can then be opened. A gate sensor may be configured to monitor that the gate is unsecured if it is detected that the locking mechanism has been rotated to the unlocked position, even if the gate has not actually been opened.

In some embodiments a second sensor or sensors such as e.g. a hook-gate sensor, may operate by a different mechanism than the first sensor or sensors. For example, in some embodiments, a gate sensor may be a so-called Hall-effect sensor. In some embodiments such a sensor may be configured to detect the presence or absence (within a predetermined distance) of a magnetic beacon that is purposefully installed in the gate. For example, such a magnetic beacon (e.g. a piece of any suitably magnetic material) may be e.g. installed into a cavity provided in a twistable portion (e.g. a locking mechanism) of the gate. The gate sensor may detect the magnetic beacon, and report its presence, when the beacon is in close proximity (e.g. when the gate is secured). The sensor may then report the absence of the magnetic beacon when the twistable portion of the gate has been twisted to unlock the gate (thus moving the beacon away from the sensor).

As noted earlier, in many embodiments the output of a fall-protection monitoring system to a latch module will include a (first) positive signal, based on information received from at least one sensor or sensors of a sensor module of the fall-protection monitoring system. In some embodiments in which first and second sensors are used, a signal from the first sensor alone, or a signal from the second sensor alone, may not be sufficient to allow a first positive signal to be generated. That is, in some embodiments an appropriate signal must be received from both a first sensor and from a second sensor. Thus, for example, a monitoring system for a gated hook may be configured so that a signal must be received from a first sensor indicating that a metal item (e.g. a metal D-ring) is or has been detected in the opening of the hook; and, a signal must be received from a second sensor indicating that the gate of the hook is secure, in order for a first positive signal, indicating that the connector of the fall-protection apparatus appears to be connected to a harness of a user, to be issued. The use of information from first and second sensors in combination is described in further detail e.g. in U.S. Provisional Patent Application No. 62/978,024 and in the resulting International (PCT) application published as WO 2020/194121, both of which are incorporated by reference in their entirety herein.

In some embodiments a sensor module may be powered by an internal source, e.g. a battery. If the sensor module is located e.g. within a housing provided on a connector, then (depending on the size of the housing and the connector) the space available for a battery may be limited. In some such cases, the battery may need to take the form of one or more “coin” or “button” batteries rather than a conventional 12 Volt battery, in order to fit within the space available. In such embodiments, it can be advantageous to configure first and second sensors of the sensor module in a way that will maximize battery life without compromising the performance of the sensor module.

For example, in embodiments in which a first sensor is a magnetic induction sensor that detects whether a metal item such as a D-ring is present within an opening of a gated hook, and in which a second sensor is a gate sensor that is Hall-effect sensor that detects whether the gate of the connector is closed and/or secured, the first, inductive sensor may exhibit a power consumption (when active) that is greater than the power consumption of the second, Hall-effect sensor, by a factor of ten, one hundred, or even one thousand. (Since many such sensors may be e.g. pulsed, any such power consumption may be averaged over a suitable overall period.)

Accordingly, in some embodiments a processor that operates the sensors may be configured so that the first sensor is not activated until the second (gate) sensor has detected a change in status of the gate, e.g. has detected that the gate has become unsecured. The first sensor may then be activated e.g. for a selected period of time as long as the gate remains in a particular condition (e.g. unsecured), and optionally for an additional selected period of time after the gate has returned to another condition (e.g. has become secured). After this, the first sensor can be returned to an inactive state in which it consumes little or no power. In some embodiments, the sensor module may be configured to inactivate the first, inductive sensor after the first sensor has detected a metal item, rather than remaining active for the duration of the selected time period, in order to further conserve power.

When a change in status of the gate is again detected, the first sensor may again be activated. Otherwise, the first sensor may remain in the inactive, low-power-consumption state indefinitely. It will be appreciated that according to the disclosures herein, not only can first and second sensors be used in combination to evaluate the status of a connector (e.g. a “ready” state may not be indicated unless the second sensor indicates that the gate is secured, and the first sensor indicates that a metal item, e.g. a D-ring, is or has been detected within the connector opening since the closing of the gate), the sensors may be collectively configured for efficient power management. That is, a more energy-consumptive sensor need only be triggered to become active upon a suitable signal being received from a more energy-efficient sensor. Thus for example, a second, gate sensor may be constantly operated (e.g. interrogating the gate via the Hall effect, up to several times a second) with little power consumption, while a first, highly energy-consuming inductive sensor may remain inactive until triggered by the processor to become active, in response to a change in gate status indicated by the second, gate sensor.

A base unit of a fall-protection monitoring system may continue to periodically send positive signals to a latch module as long as the base unit continues to receive information from the sensor module indicating that, according to the second, gate sensor, the gate of the gated hook continues to remain closed (and/or, the base unit does not receive information from the sensor module indicating that the gate has been opened). Of course, any change in the information received from the second, gate sensor may also trigger the first sensor to be activated and queried as well, with this additional information also taken into account, as discussed above.

It will be appreciated based on the discussions herein that in some embodiments, any or all of a sensor module, a base unit, and a latch module, may be configured to be powered by an internal power source (e.g. a battery) rather than relying on an external power source. Thus in some embodiments, the entire fall-protection interlocking system may rely on battery power and can thus be installed without necessitating installation of external power lines, electrical conduit and like items. (Any other items that may be present, e.g. one or more gate sensors, exit actuators, and so on, may similarly be battery-powered.) In some embodiments, one or more such batteries may be rechargeable. If the access-controlled area is situated such that it receives sufficient sunlight, one or more solar cells may be provided and configured to recharge a rechargeable battery of one or more components of the fall-protection interlocking system. In some instances all components of the interlocking system can be retrofitted to an existing barrier/gate of an access-controlled area as discussed earlier herein, e.g. in addition to being powered by an internal power source. It will thus be appreciated that the herein-disclosed arrangements can allow an access-controlled area to be interlocked with a fall-protection apparatus with a minimum of installation time and expense.

In some embodiments, a sensor module of a fall-protection monitoring system may be configured with one or more sensors that are capable of detecting more than merely the presence or absence of an item or portion thereof. By way of a particular illustration, such a sensor, as present on a connector, may be able to do more than simply report a yes/no indication of whether or not the connector appears to be attached to a detectable (e.g. metal) D-ring. Rather, the sensor may be able to provide an indication of whether the connector appears to be attached to a D-ring or appears to be attached to some other detectable item (such as e.g. a docking station). Additionally, such a sensor may be able to distinguish these from a situation in which the connector does not appear to be attached to any detectable item.

In some embodiments, such arrangements may be enhanced by equipping one or more designated items with an add-on entity that is purposefully configured to alter the inductive signature of the item in a predetermined manner. With particular regard to inductive sensing, certain materials (e.g. ferrites) may be particularly suitable for purposes of altering the inductive signature of a metal item. Such materials may be, for example, disposed in a shroud, a wrap, a molded item, or the like, to form an add-on entity which may be e.g. mounted on or otherwise disposed on or near the metal item whose inductive signature is desired to be modified. Multimodal sensing and arrangements made possible thereby, are discussed in detail in U.S. Provisional Patent Application 62/872,545 and in the resulting International (PCT) patent application published as WO 2021/005467, both of which are incorporated by reference in their entirety herein.

Discussions so far herein have primarily focused on determining whether a connector appears to be connected to a harness of a user by a combination of sensing the presence of an item in an opening of a hook and sensing the secured/unsecured status of a gate of the hook. However, it will be appreciated that the general arrangements disclosed herein, in which an access-controlled area is interlocked with a fall-protection monitoring system of a fall-protection apparatus, may be used with any sensing method or combination thereof. For example, a sensing system based on one or more cameras along with visual recognition software and appropriate processing software may be able to determine whether a connector appears to be connected to a harness of a user versus e.g. hanging from an SRL housing or docked in a docking station. It is thus emphasized that the general arrangements disclosed herein are not necessarily limited to any one sensing method or combination of sensing methods.

In some embodiments, the arrangements disclosed herein may be enhanced by configuring the fall-protection interlocking system to ascertain e.g. whether a person is within the access-controlled area and/or whether a person is outwardly-proximate the entry gate to the access-controlled area. Such methods may rely on one or more cameras, on one or more proximity sensors, and so on. A camera-based sensing system may be particularly useful e.g. in the case of an access-controlled area that comprises multiple entry gates and/or exits and/or that allows for more than one authorized person to be admitted to the area. Such a system may be able to track the occupancy of the area, the status of the entry gate(s), and so on. Camera-based sensing systems may be used for a variety of other purposes. Possible arrangements and methods of using camera-based sensing systems are disclosed in U.S. Provisional Patent Application No. 63/232,388, entitled AERIAL LIFT INTERLOCKED WITH FALL-PROTECTION APPARATUS, and in the resulting International (PCT) Application xx202x/xxxxxx that claims priority thereto; both of which are incorporated by reference in their entirety herein. It will be appreciated that various of the arrangements disclosed therein may be applied to an access-controlled area of present interest.

A base unit or units, a sensor module or modules, a latch module, and so on (in short, any or all components of the interlocking system) can communicate in any desired manner. In various embodiments, any such communication may be via wired connection or may be wireless, whether by e.g. wi-fi, a wireless local area network, Bluetooth, Zigbee, or any suitable method or protocol. Any such items may be configured in the usual manner to perform an electronic handshake or the like, e.g. to ensure that a fall-protection monitoring system is communicating with the proper latch module, and so on. In some instances, signals between any such items may be sent continuously. However, this does not necessarily have to be the case; in some instances a signal may be sent intermittently or periodically and/or as triggered by a change in status of an item being monitored.

In various embodiments, communications between the fall-protection monitoring system (e.g. a base unit thereof) and the latch module may be one-way, or two-way. If the communication is one-way, the base unit will be configured to send transmissions that are received by the latch module, but the latch module will not be configured to send transmissions that are receivable by the base unit. If the communication is two-way, both the base unit and the latch module will be able to send/receive so that information can be exchanged in both directions between the two entities. In some embodiments, two-way communication can provide that the latch module can send the fall-protection monitoring system information regarding the status of the latch as being latched or unlatched. As noted earlier, in some embodiments a gate sensor module may be provided that can send the fall-protection monitoring system information regarding the status of the gate as being opened or closed. Such information in combination can inform the monitoring system of various possible scenarios, e.g. the gate is latched, the gate is closed but is not latched, and so on. (It will be appreciated that strictly speaking, the latch module and the fall-protection monitoring system are all part of the overall interlocking system and may be configured in various ways; e.g. the base unit of the fall-protection monitoring system may be combined with the latch module.) In the event that an access-controlled area allows entry of more than one authorized person and/or comprises multiple fall-protection devices, a latch module of an entry gate (or, in some cases, multiple latch modules of multiple entry gates) may be configured to communicate with multiple base units so as to track the status of multiple fall-protection apparatus and users thereof.

Although discussions herein have primarily concerned self-retracting lifelines, it will be understood that the arrangements and methods disclosed herein may be applicable to any fall-protection apparatus that is suitable for use with the access-controlled area in question. For example, if an area is sufficiently small that the freedom to move about that is provided by an SRL is not needed, the fall-protection apparatus may take the form of, for example, a safety line that is in the form of a lanyard that is not necessarily extendable from, and retractable into, a housing in the manner of an SRL. Some such lanyards may include products (often referred to as positioning lanyards) that provide fall-restraint rather than fall-arrest. It is thus emphasized that the arrangements and methods disclosed herein encompass fall-protection apparatus that provide fall-restraint, rather than being limited e.g. to only such fall-protection apparatus as provide fall-arrest. In some embodiments, a lanyard may include at least one energy absorber (e.g. a tear strip or the like) configured to dissipate the energy in the event of a fall; such lanyards are often referred to as energy-absorbing lanyards. The arrangements and methods disclosed herein are understood to be applicable to any such lanyards and to all such fall-protection apparatus in general, with the proviso that the fall-protection apparatus, as installed, must meet any laws, rules, codes, standards, and so on, as applicable to the particular access-controlled area.

### Access-Controlled Area

An access-controlled area as generally defined herein is any area that involves a fall-risk in terms of a person falling a distance of four feet or greater, e.g. from an edge of the area into an adjacent area that is lower than the access-controlled area. The most obvious example of such an access-controlled area is an elevated platform, mezzanine or the like as may be present e.g. in many industrial settings, loading facilities, and so on. Such a platform may, for example, have one or more perimeter edges that is bordered by an adjacent area that is more than three feet below the perimeter edge of the platform. Or, an access-controlled area may be a portion, or the entirety, of a roof of a building. It will be recognized that outfitting a roof area with a fall-protection apparatus is an example of a case in which it may be beneficial to install a dedicated mast that protrudes generally above the roof area to provide an overhead anchorage so that a fall-protection apparatus can be mounted generally overhead of a person accessing the roof area.

It is noted that an access-controlled fall-risk area may take any of various forms, not all of which may necessarily comprise all, or any, outer perimeter edges that are above an adjacent area. For example, a workspace may be at the same elevation as its surroundings but may encompass e.g. an open manhole or hatch, a downward-leading loading chute, and so on, which causes the workspace to be an access-controlled fall-risk area. Still further, a fall-risk area may be an area that poses the possibility of a fall into e.g. operating machinery, water or other liquid hazard, and so on (even if such a fall would not necessarily be greater than three feet). Ordinary artisans in the field of fall-protection will readily appreciate the breadth and scope of fall-risk areas that may be protected by arrangements as disclosed herein.

An access-controlled area does not necessarily have to be stationary; rather, it may be movable in a vertical direction, a horizontal direction, or in any combination of the two. For example, an access-controlled area might be an elevatable platform of a so-called aerial work platform (e.g. a scissors lift or the like). In various embodiments, an entry gate to such an area might be installed on the area itself (e.g. installed on a platform of a scissors lift), or might be installed on a stationary entry platform from which (e.g. with the elevatable platform in a lowered position) a user can enter the elevatable platform. Even if the entry gate is on a stationary platform, in some embodiments the fall-protection apparatus (e.g. an SRL) may be resident on the elevatable platform. By resident is meant that the apparatus is directly connected to the platform or to an entity (e.g. a mast, beam, girder, or the like) that is connected to the platform, so that the apparatus moves in concert with movements of the platform. It will thus be evident that a fall-protection apparatus of an access-controlled area and a latch module of an entry gate to the access-controlled area do not necessarily have to stay in close proximity to each other at all times (e.g. they may be relatively far apart during a time that the area is elevated); however, they may often be in fairly close proximity when the user is actually entering (or exiting) the area through the entry gate.

In some embodiments, a fall-protection apparatus may be attached to an anchorage in a position that is generally above an access-controlled area that is a movable platform, but with the apparatus not being resident on the movable platform. That is, the apparatus may be attached to an anchorage that is not connected in any way to the movable platform. For example an access-controlled movable platform might be a roof of a railroad boxcar that is rolled into a designated work station (e.g. a maintenance shed) that comprises a stationary entry platform comprising an entry gate from which the roof of the boxcar can be accessed. The work station may further comprise an overhead roof (or simply an overhead girder) that provides an anchorage to which the fall-protection apparatus is attached. Or, a boom, crane or davit could extend upward from the stationary entry platform (or from any other item or location) to a position generally overhead the boxcar to provide an anchorage. It is thus emphasized that the concept of a fall-protection apparatus that is installed “at” (or “in”) an access-controlled area does not imply that the fall-protection apparatus must necessarily be attached, directly or indirectly, to the access-controlled area. All that is needed is that the fall-protection apparatus be located and configured so that it can be used by a person who is in the access-controlled area.

It will be appreciated that work platforms that are movable in a vertical and/or horizontal direction, and that may benefit from the arrangements disclosed herein, can take many forms. In general, work platforms encompass aerial lifts (e.g. order pickers) of the type that are configured to be occupied by multiple persons or by a single person. Such an aerial lift can be any powered (e.g. motorized) apparatus that comprises an user-support platform (whether open-sided, partially open-sided, or closed-sided) that can be moved at least in a generally vertical direction. In some embodiments (e.g. if the aerial lift is a cherry-picker or bucket truck) the platform may be movable in a horizontal direction and/or an angled direction rather than being limited to purely vertical movement. In many embodiments the entire aerial lift may be able to move horizontally; e.g. it may comprise a main body (e.g. a vehicle) that, in addition to supporting the vertically elevatable platform, is motorized and is steerable in a horizontal direction. For example, an aerial lift may take the form of e.g. an order picker; or, a catering truck that has a platform that is elevatable for reaching the service doors of large commercial airliners. Some such aerial lifts may be equipped with an interlocking arrangement that prevents the aerial lift at least from being elevated unless it is detected that the a connector of a fall-protection apparatus of the aerial lift appears to be connected to the harness of the user of the aerial lift. Arrangements of this general type are disclosed in U.S. Provisional Patent Application No. 63/232,388, entitled AERIAL LIFT INTERLOCKED WITH FALL-PROTECTION APPARATUS, and in the resulting International (PCT) Application xx202x/xxxxxx that claims priority thereto, both of which are incorporated by reference in their entirety herein. Any such arrangements may be used in combination with those disclosed herein.

In various embodiments, an aerial lift with which a fall-protection system and a fall-protection monitoring system as disclosed herein may be used, can be, in addition to the specific apparatus and categories already named, a so-called aerial work platform, a scissor lift, an order picker, a reach truck, and so on. All that is necessary is that the aerial lift be of a configuration that allows an entry gate to be positioned (whether the gate is resident on the aerial lift, or e.g. on a stationary platform from which the aerial lift can be entered) so as to be openable and closable to allow access to a user-support platform, and that the aerial lift be able to be equipped with a fall-protection apparatus such as an SRL.

Some aerial lifts as conventionally available may not necessarily be equipped with an overhead-installed fall protection apparatus (e.g. a self-retracting lifeline (SRL)). However, if it is desired that an SRL be used with such an aerial lift, the lift can be specially modified (e.g. equipped with a vertical mast of any suitable height, on which the SRL can be mounted) to allow this, as long as such modification is in compliance with all applicable laws, rules, codes, standards, and so on.

In general, similar arrangements may be made with any access-controlled area (whether movable or not) that does not comprise a suitable support structure that can inherently provide an anchorage that is generally overhead of the access-controlled area. In such instances, a mast (e.g. a generally upwardly-extending mast) can be securely attached e.g. to the “floor”, of the area and can extend e.g. at least generally upward to provide an anchorage. Or, a mast or strut may be securely attached to any entity that is adjacent the access-controlled area and can extend into a space above the access-controlled area to provide an anchorage. As noted, in some embodiments any such anchorage may be fixed or may be movable, e.g. in one or more horizontal directions and/or in a vertical direction and/or in any combination of horizontal and vertical directions.

In some instances an interlocking system as disclosed herein may be installed at a permanent location, e.g. a warehouse, loading facility, or the like. In such a case, the above-described entry gate (and any fixed fall-protection barriers associated therewith) will likely be a permanently installed item. However, in some embodiments an interlocking system may be used with an entry gate (and any fall-protection barriers associated therewith) that is configured to be transported and then installed for a limited time at a selected location, e.g. at a construction site during a particular phase of construction. Such an interlocking system might, for example, find use with a portable fall-protection system of the general type exemplified by the 3M DBI-SALA 4-in-1 Davit Guard System, if the guard (barrier) system is equipped with an entry gate in the general manner disclosed herein. It will be apparent that an interlocking system that is battery powered may be particularly advantageous in such circumstances.

The above discussions have made it clear that a fall-protection monitoring system as disclosed herein may be configured in multiple different ways. Some arrangements (e.g. in which a connector of a fall-protection apparatus is equipped with a sensor configured to detect a D-ring of a user's harness) may provide a “direct” indication that the connector appears to be attached to the D-ring and thus may provide a direct indication that the harness of a user appears to be connected to the safety line of the fall-protection apparatus. Other arrangements may provide a direct indication of some other status of the connector (e.g. an SRL housing may be equipped with a sensor that is able to provide a direct indication that the connector appears to be snugged against the SRL housing) and thus may provide an “indirect” indication that the connector does not appear to be connected to the user's harness. It will thus be appreciated that the arrangements and methods disclosed herein may be used in a variety of ways and implementations, any of which may be used in combination.

It is emphasized that regardless of the functioning of any interlocking system as described herein, a user who enters an access-controlled area will be tasked with carrying out any appropriate steps (e.g. as required by applicable laws, rules, codes, standards, and/or instructions) e.g. to verify that the connector of the fall-protection apparatus is securely attached to the user's harness. Under no circumstances will the presence of any arrangement as disclosed herein relieve such a person of the duty to follow all appropriate laws; rules; codes; standards as promulgated by applicable bodies (e.g. ANSI); instructions as provided by the manufacturer of an elevatable work platform, instructions as provided by the manufacturer of the fall-protection system; instructions for use of any particular equipment or machinery that is located within the access-controlled area, instructions as provided by the entity in charge of a facility in which the access-controlled area is located, and so on. Nor may a fall-protection interlocking system as disclosed herein be installed or configured in a way that violates any applicable law, rule, code, and so on. That is, many possible arrangements have been described herein; this is for completeness of disclosure and does not imply that any particular arrangement may be used in a jurisdiction in which it would be in violation of a law, rule, code, standard, etc.

It will be apparent to those skilled in the art that the exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any discrepancy between this specification as written and the disclosure in any document that is incorporated by reference herein but to which no priority is claimed, this specification as written will control.

What is claimed is:

1. A fall-protection interlocking system for an access-controlled fall-risk area comprising an entry gate, the system comprising:
a normally-latched, low-power-consumption latch module that is installed at the entry gate;
a fall-protection apparatus that is installed at the access-controlled area and that comprises a safety line with a distal end comprising a connector configured to be connected to a safety harness worn by a user of the access-controlled area, and
a fall-protection monitoring system that is in communication with the low-power-consumption latch module and that is configured to determine whether the connector of the safety line appears to be connected to the safety harness of the user,
wherein the fall-protection apparatus is positioned and configured so that the distal end of the safety line is graspable by the user when the user is located outwardly-proximate to the entry gate,
and wherein the fall-protection monitoring system is configured to send a positive signal to the low-power-consumption latch module when the fall-protection monitoring system determines that the connector of the safety line appears to be connected to the safety harness of the user, and wherein the low-power-consumption latch is configured to unlatch the entry gate upon receiving the positive signal from the fall-protection monitoring system.

2. The fall-protection interlocking system of claim 1 wherein the access-controlled fall-risk area is stationary.

3. The fall-protection interlocking system of claim 1 wherein the access-controlled fall-risk area is movable.

4. The fall-protection interlocking system of claim 1 wherein the fall-protection interlocking system is configured so that upon receipt of the positive signal, the low-power-consumption latch module unlatches the entry gate and maintains the entry gate in an unlatched condition until the fall-protection monitoring system detects that the connector of the safety line appears to be not connected to the safety harness of the accessor, whereupon the fall-protection monitoring system sends a negative signal to the low-power-consumption latch module, and wherein upon receipt of the negative signal, the low-power-consumption latch module relatches the entry gate.

5. The fall-protection interlocking system of claim 1 wherein the fall-protection interlocking system is configured so that upon receipt of the positive signal, the low-power-consumption latch module unlatches the entry gate for a predetermined time period, after which the low-power-consumption latch module relatches the entry gate.

6. The fall-protection interlocking system of claim 1 wherein the system comprises at least one exit actuator that is accessible by the user from within the access-controlled area and that can be actuated by the user to send an actuation signal to the low-power-consumption latch module, and wherein upon receipt of the actuation signal the low-power-consumption latch module unlatches the entry gate.

7. The fall-protection interlocking system of claim 1 wherein the system comprises at least one override actuator that is accessible from outside the access-controlled area and that can be actuated to send an override signal to the lower-power-consumption latch module, and wherein upon receipt of the override signal the low-power-consumption latch module unlatches the entry gate.

8. The fall-protection interlocking system of claim 1 wherein the fall-protection monitoring system comprises a base unit and comprises at least one sensor module mounted on the connector and configured to sense whether the connector appears to be connected to the safety harness and to communicate connector status information to the base unit that is indicative of whether the connector appears to be connected to the safety harness; and wherein the base unit is configured to receive the connector status information from the at least one sensor module, to transmit the positive signal to the low-power-consumption latch module if the connector status information received from the at least one sensor module indicates that the connector appears to be connected to the harness, and to transmit a negative signal to the low-power-consumption latch module if the connector status information received from the at least one sensor module indicates that the connector does not appear to be connected to the harness.

9. The fall-protection interlocking system of claim 1 wherein the fall-protection apparatus comprises a self-retracting lifeline (SRL) comprising a housing, with a proximal end of the safety line of the fall-protection apparatus being connected to a drum that is within the housing of the SRL and is rotatably connected to the housing of the SRL and with the safety line being extendable out of the housing and retractable into the housing; and, wherein the housing of the SRL is attached to a support structure that is generally overhead of the access-controlled area.

10. The fall-protection interlocking system of claim 9 wherein the housing of the self-retracting lifeline is fixed at a location that is selected so that the distal end of the safety line is graspable by the user when the user is located outwardly-proximate to the entry gate.

11. The fall-protection interlocking system of claim 9 wherein the housing of the self-retracting lifeline is movable in at least one generally horizontal direction along at least a portion of the access-controlled area to at least one location at which the distal end of the safety line is graspable by the user when the user is located outwardly-proximate to the entry gate.

12. The fall-protection interlocking system of claim 1 wherein the low-power-consumption latch module is battery-powered and is not connected to any external power source.

13. The fall-protection interlocking system of claim 1 wherein the low-power-consumption latch module comprises a latching solenoid lock.

14. The fall-protection interlocking system of claim 1 wherein the low-power-consumption latch is installed at the entry gate by way of being retrofitted onto an existing entry gate.

15. The fall-protection interlocking system of claim 1 wherein the entry gate is biased toward a closed position by a mechanical biasing system that is separate from, and independent of, the low-power-consumption latch module.

16. The fall-protection interlocking system of claim 1 wherein the system comprises a docking station that is located proximate the entry gate and to which the connector can be docked when not connected to the harness of the user.

17. The fall-protection interlocking system of claim 1 wherein the system is configured so that after the fall-protection monitoring system has determined that the connector of the safety line appears to have been connected to the safety harness of the accessor and the low-power-consumption latch module has unlatched the entry gate, if the base unit of the fall-protection monitoring system wirelessly receives connector status information from the at least one sensor module indicating that the connector no longer appears to be connected to the harness, the fall-protection monitoring system will emit at least one warning notification indicating that the connector does not appear to be connected to the harness.

18. The fall-protection interlocking system of claim 1 wherein the system further comprises an entry gate sensor module comprising one or more sensors that can ascertain whether the entry gate is closed or is open so that the entry gate sensor module can provide a “closed” or “open” auxiliary signal to the fall-protection interlocking system.

19. The fall-protection interlocking system of claim 1 wherein the system further comprises a user authorization module that can ascertain whether a person is an authorized user of the access-controlled area so that the user authorization module can provide an “authorized” or “not authorized” secondary signal to the fall-protection interlocking system.

20. A method of controlling access to an access-controlled fall-risk area, the method comprising:
receiving a positive signal indicating that a connector of a safety line of a fall-protection apparatus that is installed at the access-controlled area appears to be connected to a safety harness of a user located outwardly-proximate to an entry gate to the access-controlled area;
upon receiving the positive signal, using a low-power-consumption latch module that is installed at the entry gate to unlatch the entry gate so that the entry gate can be temporarily opened so that the user can enter the access-controlled fall-risk area through the opened entry gate.
